(19) United States
(12) Patent Application Publication
(10) Pub. No.: US 2015/0117745 A1
(43) Pub. Date: Apr. 30, 2015

(54) Method, system and a service for analyzing samples of a dried liquid

(71) Applicant: Droppi Veripalvelu Oy, Keminmaa (FI)

(72) Inventors: Mikko Vapa, Keminmaa (FI); Aki Huttunen, Oulu (FI); Niko Kotilainen, Raakkyla (FI); Marko Vapa, Keminmaa (FI); Janne Heikkila, Oulu (FI)

(73) Assignee: Droppi Veripalvelu Oy, Keminmaa (FI)

(21) Appl. No.: 14/066,828

(22) Filed: Oct. 30, 2013

(30) Foreign Application Priority Data
Oct. 30, 2013 (FI) 20136061

(51) Int. Cl. G06K 9/00

(52) U.S. Cl. CPC G06K 9/00134; G06K 9/00147; G06K 9/0014
USPC 382/134

(57) ABSTRACT

This invention relates to a method, a system and a service for analyzing biological liquids like blood and to assess the quality of such liquid. The analysis is made on a plurality of dried drops of the liquid as samples on a substrate, and involves scanning the substrate to create an image of the dried samples on the substrate. The image of the samples is processed in order to segment and qualify the samples into images of defined sample drops for further processing, whereafter they are grouped into at least one group of samples. The samples are analyzed to retrieve the total areas having at least one predetermined color and to retrieve the total areas for each predetermined color in the drops, whereby a ratio is calculated of the total area of the defined sample drops versus the total areas of the at least one predetermined color areas to achieve a quality indication of the liquid.

### FIELD OF THE INVENTION

This invention relates to a method, a system and a service for analyzing samples of a dried liquid. More specifically, it relates to analyzing biological liquids like blood and to assess the quality of such liquid.

### BACKGROUND OF THE INVENTION

Machine vision is a technology used to provide imaging-based automatic inspection and analysis for a variety of applications industry, also in medicine. One research area in that field is the analysis of visual features of blood drops. An important step is the development of digital imaging techniques to a level where small samples can be digitized to virtual blood samples with a high resolution. Such samples enable the development of virtual microscopy applications, like finding malaria infection from red blood cells [1].

Most of the machine vision applications in virtual microscopy are based on the use of stained or live blood samples. Research in the field of dry blood is much more sparse and less known. Dry blood analysis means a method where blood samples from a fingertip are put on a glass substrate and left there to dry. The purpose is to give some information about the state of the body. An early scientific publication on dry blood samples taken from the fingertip is by H. L. Bole [2] and is from 1942. The test developed by Bole was as such mainly used for detecting cancer, and it has been verified that about 85% of advanced cancer patients have a “white dry blood”, i.e. a blood purity of less than 50%. Blood purity is a measure between 0-100%, and depends on criteria like the amount of whiteness in the dry blood, and the total area of dark spots in a drop of dry blood. It is also known how to use dried blood samples for DNA scanning.

In terms of patent literature, there is little available concerning automated measuring of dry blood samples. AU2007100331A4 discloses a method for “health reporting” using live and dry blood analysis based on dark and bright field microscopy. However useful such a report maybe, it involves quite a few measurements and process steps before any data can be automatically processed to produce such a report. The method also does not utilize machine vision methods to analyze the blood images.

In WO2012030313A1 is presented a method and device for automatic analysis of blood or bone marrow. It is also based on microscopy, and is intended for blood cell counting using an image recognition system. This method requires also very specific equipment and does not give an overall blood purity indication, but to study stained cells to provide counts of red and white blood cells and platelets.

WO2012142496A1 discloses a method for determination of hemoglobin content or cell volume for red blood cells or platelets by illuminating a sample with incident light at a plurality of illumination wavelengths. A two-dimensional image of the sample is obtained, and an optical density corresponding to each of the illumination wavelengths is determined. This document does not mention dry blood samples and the imaging resolution shown is only enough for identification of blood cells and platelets. Again, a complicated and specific hardware setup is envisaged.

### OBJECT OF THE INVENTION

It is the object of the present invention to provide for a highly automated, efficient and reliable method for automatic blood health state determination by analyzing dry blood purity and the dry blood patterns visible in the blood. Dry blood analysis may show mineral deficiencies, organ stresses and other problems of the body. With dry blood analysis it is easy to monitor a person's health status and how it progresses.

In dry blood analysis, drops of blood from a fingertip or other part of the body is taken on a glass plate. The sample may consist of about eight blood drops and it is taken by pressing a glass plate gently on the skin or the fingertip. As the sample taking proceeds, the size of the drops is reduced giving a pattern of sample drops with a different and gradually reduced size on the glass plate. This is beneficial, as the blood behaves somewhat differently in drops of different sizes, which means the amount of information available is larger. When a drop of blood dries, radially directed liquid flows can be observed, resulting in that different components of the blood are on specific distances from the center of the drop. This results in reproducible patterns that can be analyzed and recognized as profiled [2, 11].

The blood drops dry within a couple of minutes and after drying they can be inspected with a scanning device. If the blood is in a healthy state then the body is usually in a good shape and the blood dries remaining red. If drying produces a mixed color profile, the blood contains excessive waste products, which can be seen as white protein pools.

As an example, blood purity was measured from 1160 individuals, all Finns. The average value was 84.5%. Blood purities below 70% and above 90% are rare. All blood purities below 50% have been measured from hospital patients. The main findings are that vegetarians and those meat eaters who drink purifying liquids have the cleanest blood. In contrast, those who stay up late, are obese, drink alcohol, smoke or are stressed as well as those who have 4 or more diagnosed diseases have the lowest quality of blood.

### SUMMARY OF THE INVENTION

The inventive method comprises the steps of:
providing a plurality of dried drops of said liquid as samples on at least one substrate;
   scanning said at least one substrate and creating an image of the dried samples on the substrate;
   processing the image of the samples in order to segment and qualify the samples into images of defined sample drops for further processing;
   grouping the defined sample drops into at least one group of samples;
   analyzing the defined sample drops to retrieve the total areas having at least one predetermined color;
   summing the retrieved areas of the defined sample drops to retrieve the total areas for each of the predetermined colors in said drops,
   calculating a ratio of the total area of the defined sample drops versus the total areas of the at least one predetermined color areas to achieve a quality indication of the liquid.

In a preferred embodiment, the liquid is blood and the predetermined color is red. Other embodiments of the inventive method are presented in the appended claims and in detail in the sections to follow.

The inventive system for analyzing samples of a dried liquid, where a plurality of dried drops of samples of the liquid is provided on at a substrate, includes:
an imaging device for creating an image of the dried samples on the at least one substrate;
storage means for storing image data and program products for processing image data; a computer for:
   processing the image of the samples in order to segment and qualify the samples into images of defined sample drops for further processing;
   grouping the defined sample drops into at least one group of samples;
   analyzing the defined sample drops to retrieve the total areas having at least one predetermined color;
   summing the retrieved areas of the defined sample drops to retrieve the total areas for each of the predetermined colors in said drops;
   calculating a ratio of the total area of the defined sample drops versus the total areas of the at least one predetermined color areas to achieve a quality indication of the liquid; and
a display for showing the calculated quality indication to a user of the system.

In one embodiment the imaging device is a scanner for scanning e.g. photographic pictures into a digital image format. The scanner may be adapted or used as such to scan and image dried liquid samples on the substrate and to send the images to said computer for further processing. Alternatively, the imaging device may be a personal device such as a mobile phone equipped with a camera. The user takes pictures of dried liquid samples and send them to a remote computer for further processing. The user will then receive a quality indication of said liquid from the remote computer.

A service for analyzing dry blood samples according to the present invention uses the inventive method and system for providing an end user with health-related information based on blood information, which according to one embodiment is erythrocyte sedimentation rate of the sampled blood.

### BRIEF DESCRIPTION OF THE DRAWINGS

The invention is described in more detail in the following by making reference to the attached drawings, where:

FIG. 1 shows to an original and a calculated picture of a sample;

FIG. 2 is a flowchart of the drop candidate selection process;

FIG. 3 is a flowchart over the final segmentation and qualifying process;

FIG. 4 shows an example of a successful segmentation;

FIG. 5 is shown an example of the result of a Hough-transform used in the present invention;

FIG. 6 shows an example of successful sample segmentation;

FIG. 7 shows an example of the formation of samples;

FIG. 8 is a flowchart of grouping samples;

FIG. 9 shows examples of poorly dried blood drops;

FIG. 10 is a flowchart of determination of blood purity;

FIG. 11 shows examples of color histograms used in the present invention;

FIG. 12 shows the formation of an optimal decision borderline in a two-dimensional feature space;

FIG. 13 shows examples of drops used in the learning process;

FIG. 14 shows examples of drops containing dark spots;

FIG. 15 is a flowchart on the detection of dark spots;

FIG. 16 shows an example of a drop where the dark spots have been located;

FIG. 17 shows a graph on the correlation between two samples;

FIG. 18 is a bar chart over the difference distribution between two samples;

FIG. 19 shows a bar chart over the distribution of the blood purity values;

FIG. 20 show an embodiment of the inventive system;

FIG. 21 shows another embodiment and a service concept of the inventive system.

### DETAILED DESCRIPTION OF EMBODIMENTS

The inventive method consists of a sample taking procedure as described above, and of the following main process steps:
preprocessing of the sample images, by
   classifying and defining candidate liquid sample drops;
   segmentation of the drops, by fading out the background surrounding the drops and forming the final sample drop outlines and images;
dividing the drop images into sample groups, by
   defining sample tray lines and eliminating other background traces; OR
   defining mathematically candidate lines that separates drops into samples;
   dividing the drops into sample groups along optimal selected lines;
discarding poorly dried or drops containing anomalities;
defining the partition of a desired color component in the liquid, by
   reducing and selecting the principal sample dimensions;
   mapping the sample properties (colors) to be analyzed into histograms;
   teaching a color classifier with learning samples (to be done once for each color and type of analysis);
   applying the classifier to recognize and estimate areas occupied by a component other than the desired one in the samples;
   defining and counting the areas of any dark (black) spots in the samples;
calculating a ratio of the area of the desired predetermined component versus the total area of any undesired components in the samples.

In the following, each of these process steps is explained in more detail by means of examples of algorithms and methodology that may be used, in the case of dry blood analysis.

In preprocessing of the sample images, by classifying and defining candidate liquid sample drops, a Naive Bayes classifier (see references 3-6) can be used. A Bayesian classifier assumes that the presence or absence of a particular feature is unrelated to the presence or absence of any other feature, and is one of the foremost statistical methods that are used in machine vision technology. In Bayesian classifiers the classification problem is expressed with probability variables, and the purpose is to give an object a class label according to selected criteria. Bayesian classifiers can be used also for segmentation, especially in cases like the present invention, where it is of interest to partition an image into regions and be able to assign to a region in a picture a probability value according to how probable it is that it belongs to a particular class.

If we have a prior belief that the probability distribution function is p(θj) over classes j (j=1 . . . n), and there are observations X with the likelihood p(X|θj) in class j, then a posterior probability, i.e. the probability that an observed object X will belong to a particular class j is defined as

$$p ( θ j \vert X ) = \frac{p ( θ j ) p ( X \vert θ j )}{p ( X )} \qquad ( 1 )$$

where p(X) is the probability of X in all classes according to the total law of probability.

The Bayesian classifier needs to be taught the probability that a pixel with certain properties is blood. This can be done by learning the classifier with model learning samples that belong to a known class, using for example the RGB color model and by creating a two-dimensional histogram for the vital colors, i.e. R and G. If each dimension has e.g. 64 levels in the histogram, it gives a sufficiently accurate palette for defining the borders of each blood drop and the minimum size of a drop.

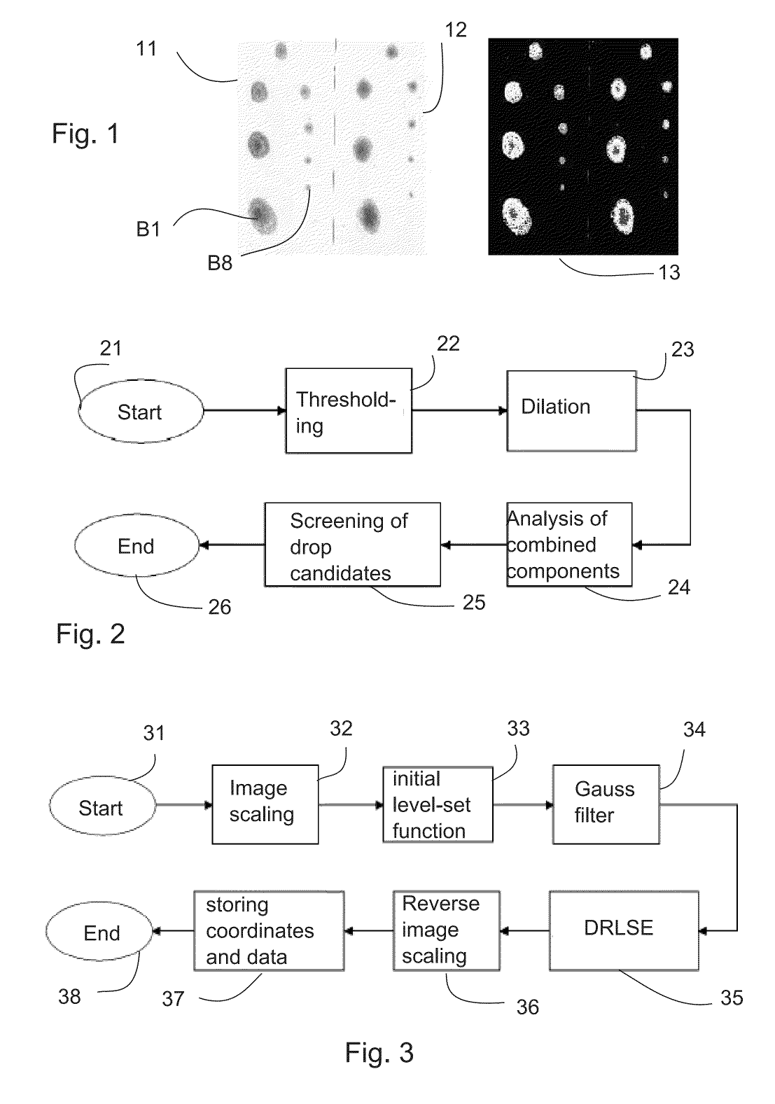

FIG. 1 shows to the right the original picture taken of a sample consisting of two glass plates 11, 12 with 8 blood drops B1-B8 on each. Note the diminishing size of the drops, the ones taken first being much larger than the last ones. The picture on the right is a calculated probability picture 13 of the same sample 11, 12.

Using the histogram and applying formula (1), a Bayesian probability picture for the pixels may be produced which means a defined digital representation of the blood drops on the substrate is produced. In order to select suitable drop candidates for further analyzing in this processing stage, the following validation steps 21-26 may be taken also shown in FIG. 2:
thresholding 22 the probability picture e.g. by 0.5, in order to sharpen the edges or borderlines of the drops;
drop border analysis by dilation 23 for deciding whether nearby drops are to be considered as one drop or not;
shape and neighboring area analysis by a combined component analysis 24 in order to separate drops from smear or stains that cannot be reliably considered as blood drops [16], and
screening 25 the size of the drops to weed out mere droplets splashed from larger drops.

According to applicant's experience, a drop should consist of at least 2500 pixels in a 2400 dpi resolution image, in order to be meaningfully processed and carry sufficient information.

FIG. 3 shows a flowchart 31-38 over the final segmentation and qualifying process. The preprocessing of the sample images continues by performing first a scaling 32 and then a segmentation of the drops, by fading out 33, 34 the background surrounding the drops and forming the final sample drop outlines and images. This can be done e.g. with a DRLSE [7] algorithm 35 (Distance Regularized Level Set Evolution), using the RGB intensity levels mentioned above. DRLSE is a well-known algorithm used for image segmentation in medicine and other fields of science. Also other Level Set Function (LSF) methods known in the art are possible to use. Subsequently, the images are scaled back 36 to the original size and the final coordinates of the drops are determined 37.

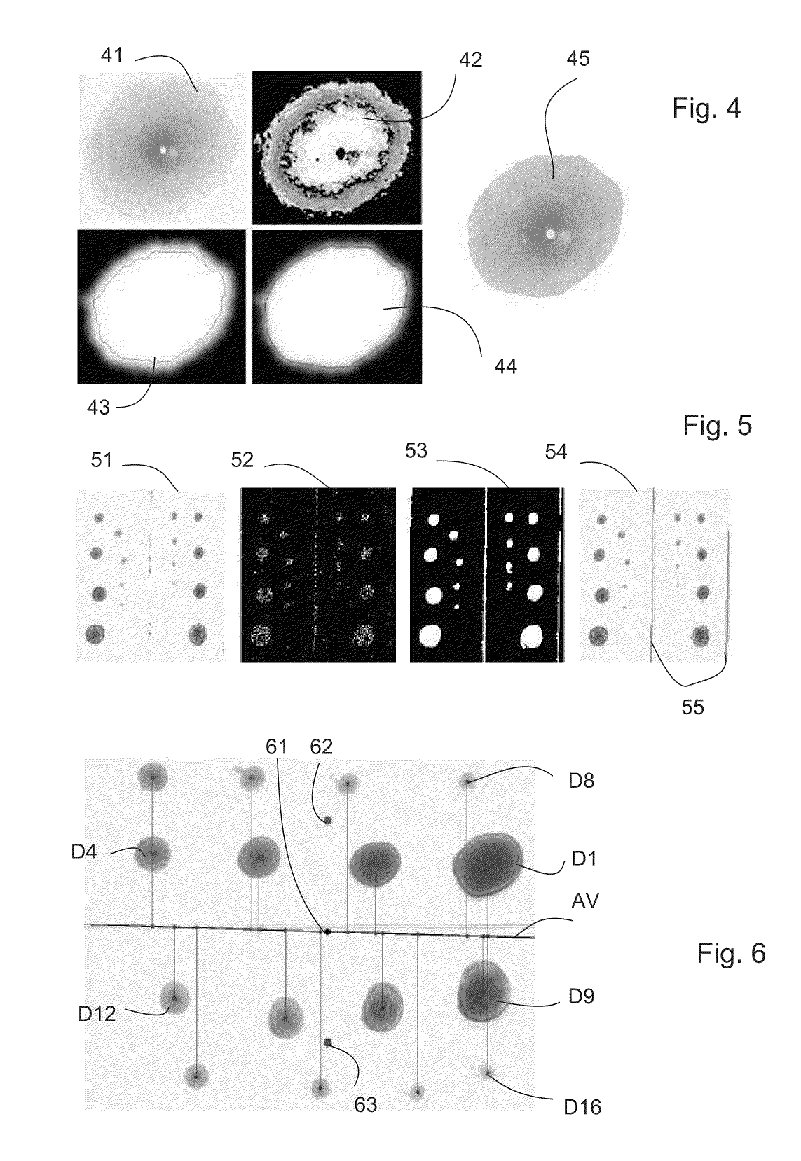

FIG. 4 shows an example of a successful segmentation. On the top left is the original picture 41, beside it is the probability image 42, down to the left is a filtered image 43, next to it an image 44 with the final contour outlined, and to the right is the end result 45 of the segmentation.

Hereafter the drop images need to be divided into at least one sample group. It is crucial that a sufficient high number of blood drops are sampled, in order to even out differences caused by the sample taking, substrate and other factors. Sample taking for dry blood is a rather manual process full of individual-related variables in the way the samples are gathered, the first step is therefore qualitative in nature and is about to validate the blood drops. This has been described above. The next step now to be described is more quantitative in nature, and concerns the formation of standard sample groups, of which there can be on one or several of. However, it is also quantitative in that some blood drops may be discarded, which is explained later on.

The dry blood samples can be taken on standard laboratory or microscopy glass slides, typically 76×26 mm in size and with a thickness of approx. 1.0-1.2 mm. In order to take a sufficient amount of samples, up to three slides may be collected with blood drops from a finger. A suitable amount of drops per slide is eight. All sample slides from the same individual are simultaneously scanned with a photo or slide scanner, which are shortly discussed under the examples section. The first task for the sample grouping is to determine the division line between the sample groups. The simplest way is to use the borderlines of the glass substrate slides as borderlines, as they are usually visible in the scanner picture. This can be done with a Hough transform, which in its classical form as described in U.S. Pat. No. 3,069,654 was concerned with the identification of lines in an image. Contrast enhancing, morphology operation and filtering may be used to improve the accuracy of the transform. In a Hough transform, each pixel of the picture is studied, as well as its neighboring pixels, and the information is stored in an accumulator matrix. If a pixel is determined to belong to an edge segment, parameters including the coordinates and the direction of the line passing through the pixel is quantized and updated in the matrix. When all pixels have been processed, the highlight coordinates in the matrix point to potential line candidates in the pictures. These line candidates are then validated, e.g. two parallel lines close to each other (the edges of neighboring glass plates) are combined, and so on.

In FIG. 5 is shown an example of the result of a Hough-transform. To the left is the original picture 51 transformed to a greyscale image, the next to the right is the image 52 processed with a Sobel-operator, producing a gradient approximation of the image intensity. Next, the image 53 has been processed with morphological operations, and to the far right is the end result 54, where the validated lines 55 are marked.

However, it may be the case that the blood samples are all taken on a larger substrate, or the glass slides fit together well so that the scanner does not capture the borderline between them. A more generic method of dividing the samples into groups may therefore be needed. As long as it can be assumed the blood drops are put on the substrate used for collecting the samples according to some logic, i.e. with regular intervals in rows and columns, or if randomly at least with a minimum distance from each other, mathematical algorithms can be used for grouping the drops into samples. One such algorithm is the mean vector and covariance matrix method supplemented with a LDA classifier (Linear Discriminant Analysis [8], p. 588-596). The mean vector produces a dividing line between the blood drops where the mean distances from the center of mass from each drop are the same on both sides of the line. The optimum vector, where the mean distance is largest, can be determined by rotating the vector and iterating the calculation for each angle. The LDA algorithm, which explicitly attempts to model the difference between classes of data, cannot be used as such because there is no class label assigned to the individual drops. However, with a mean vector we can produce classes of drops on different sides of a candidate vector, and let the LDA algorithm do the fine-tuning of finding the best vector for the sample grouping. In short, the LDA strives to minimize the standard deviation matrix inside the groups and to maximize the standard deviation matrix between the groups. For the sake of simplicity the full LDA mathematical formulas are not presented here, but they can be seen and explained in full in e.g. in [9]. If the ratio of these matrices is maximized, i.e. the criteria

$$cr = \frac{det \vert {S}_{b} \vert}{det \vert {S}_{w} \vert} . \qquad ( 2 )$$

is maximized, where S_{b} is the standard deviation matrix between the groups (classes) and S_{w} is the standard deviation matrix inside one of the groups (within-class).

In FIG. 6 is shown an example of a successful sample segmentation, where the dot 61 denotes the position of the average vector AV, and the upper 62 and lower 63 dots denote the average distance of the drops D1-D8; D9-D16 in the sample from the dividing average vector line AV.

With three groups or classes two dividing lines must be determined. A starting point is to define two parallel projection lines that are gradually moving away from the mean vector in opposite directions in steps with a predetermined length, and calculating the cr-criteria separately for the two groups on opposite sides of each projection line. Then the projection lines are shifted again, until the projection lines reach the edges of the image area. For each position of the lines, the angle of them may be tilted between 0−π and the cr criteria re-calculated. Finally, the line positions for both lines that yields the greatest mean value of the criteria cr, is chosen as the dividing lines for the three sample groups.

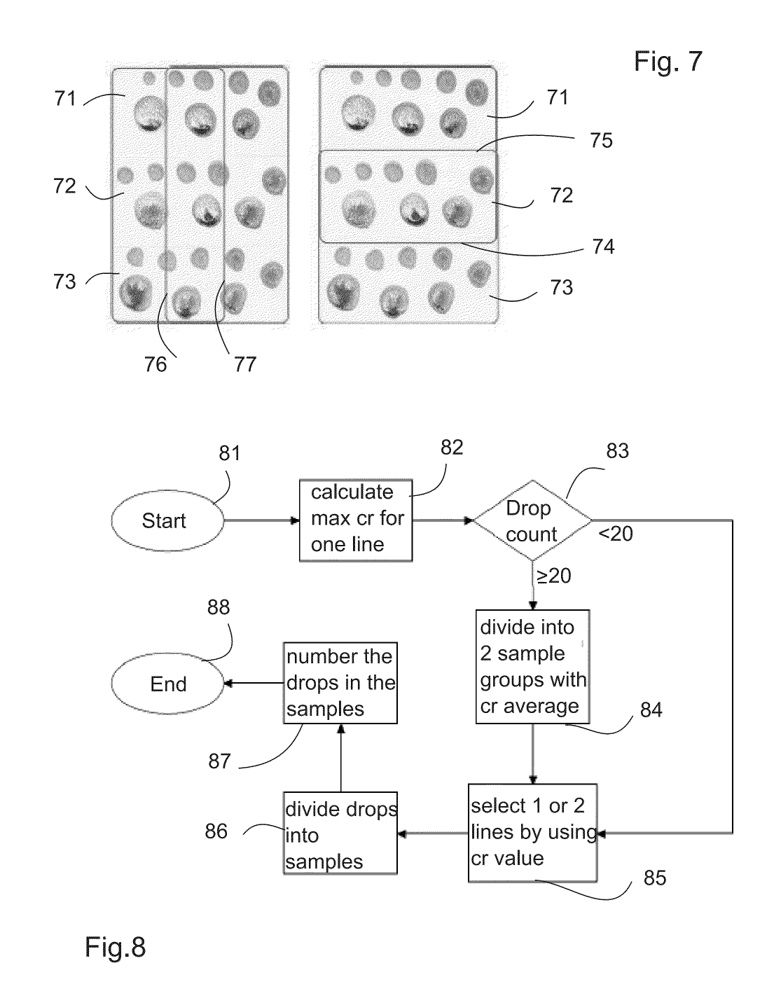

FIG. 7 shows an example of the formation of samples, with three samples 71-73 of 8 drops each. The sample groups are attempted to be formed by two dividing lines in two different configurations. The sample grouping with lines 74 and 75 to the right has been successful, while the attempt to the left with lines 76 and 77 has been unsuccessful and is discarded.

If there are more than three groups of samples, the algorithm may split the groups to be processed separately to groups of three, for example. The number of drops determines how the groups are formed; a small number of drops, say 10 or below, need only one or two groups.

FIG. 8 shows a flowchart 81-88 of grouping samples in a case with two or three samples, as described above. The sample drops are partitioned at 82 with one dividing line, The number of drops are considered at 83, if they are 20 or more the samples are divided in two groups at 84 and the mean value of the cr criteria of the groups is calculated. based on the value, a one or two dividing line approach is selected in 85, whereafter the drops are divided into samples at 86 and numbered at 87.

Blood drops that are too thick and/or have not dried sufficiently on the substrate before scanning should be discarded. This is done after grouping the samples, in order not to complicate the algorithms unnecessarily. The rejection algorithm is based on color information of the drops and a calculated three-dimensional histogram based on RGB information. The histogram for each drop is compared to a histogram consisting of the sums of histograms for drops used as learning data. This will reveal areas of blood that have not dried satisfactorily, and a threshold value is set for how big portion of the drop can consist of such areas before it is discarded.

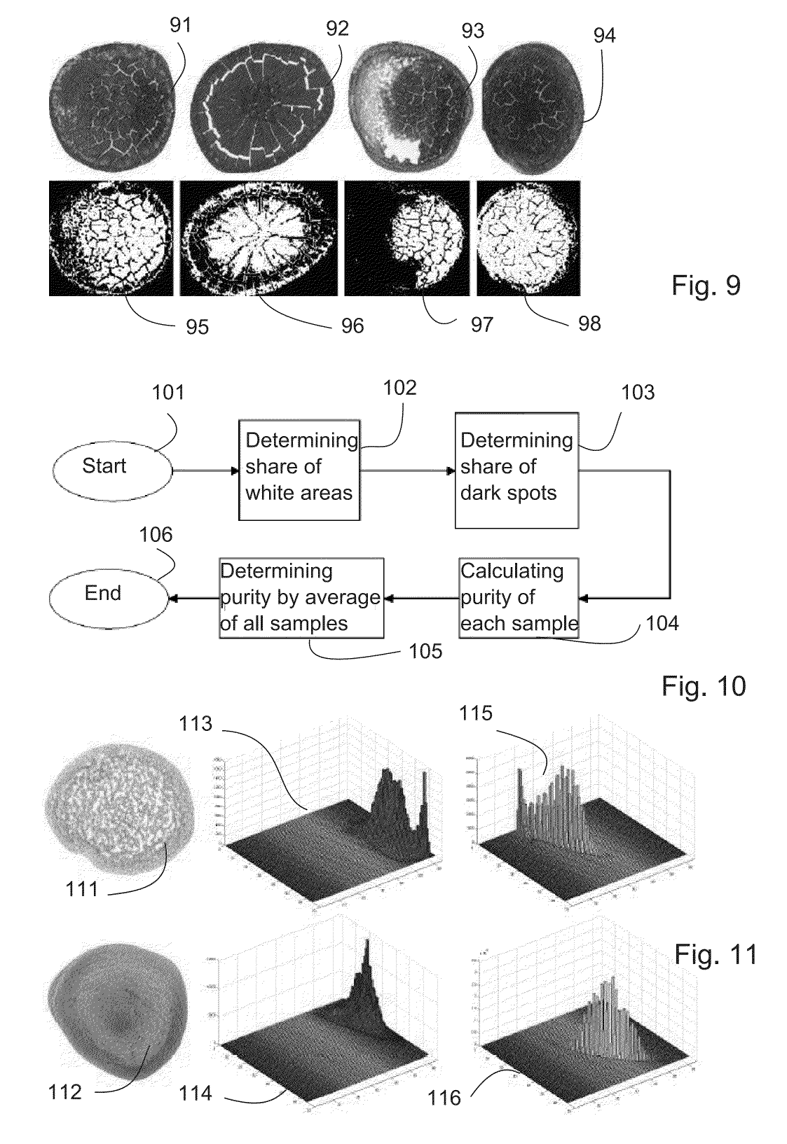

FIG. 9 shows in the uppermost row examples of poorly dried blood drops 91-94. The common fault is that the fingertip has not touched the sample substrate, i.e. the glass plate, which causes structure and color distortions. The learning data representation for such cases are shown in the lowermost row of images 95-98.

### Determination of the Purity of Dry Blood

In this section, the classification of the blood drops is described. The drops each have areas with the desired color component, that in the case of blood is the predominant red color, and areas that are lighter and/or darker than red.

FIG. 10 shows a flowchart 101-106 of determination of blood purity, where is, as an example, calculated the areas of “white blood” in 102 and dark spots in 103 of each sample drop, and the blood purity is determined by averaging 105 the processed partitions in one drop 104 over the whole sample.

The most important factor influencing the purity of blood is the amount of so-called white blood in the total amount of blood in the drop. The appearance of the white blood may vary greatly from one drop to another, which is why simple threshold-setting methods and pixel-counting are not reliable enough. The most important factors to consider are the color and size of the drop. The smaller the drop, the less blood is in it and the thinner it usually then is. This indicates that a small drop can appear much more pale or lighter than a larger drop of the same blood. A useful algorithm to use in the purity classification of the drops is Support Vector Regression (SVR). In SVR, the support vector machine is here applied to cases with sliding class scales [10, p. 339-344].

Before applying the SVR classifier to determine the blood purity, the samples need to be standardized with regard to the variables present, most notably color and size, in order to provide for automated analysis. Standardization means here reducing the number of dimensions or variables to a reasonable level, and to quantize them. Too many dimensions in a data set to be input to a classifier leads to heavy numerical processing and to over-fitting of the classifier, resulting in processing random noise rather than relevant feature data, with no benefit for the end result.

First, the relevant feature spaces need to be selected and processed. A first step to process the color information is to create a histogram, preferably a 2-dimensional one, to keep the processing burden at a reasonable level. The components used for describing the color space may use some of the RGB encoding models HSL (hue, saturation, lightness), HSV (hue, saturation, value) or HSI (hue, saturation, intensity), or YCbCr, in any combination considered optimal for the purpose. The histograms are quantized to 64 levels, where a two-dimensional approach then gives 64×64=4096 different color information elements. Thereafter the histograms are normalized so that the sum of each histogram is 1, so that each drop of blood will have a comparable histogram independent of the drop size.

FIG. 11 shows examples of color histograms used in the present invention. The histograms are formed from two different blood drops 11 and 112, to the right 115, 116 by using r- and S-components, to the left 113, 114 by calculating the R- and G-components.

After this, a Principal Component Analysis (PCA) analysis may be performed in order to produce “reduced” histograms. Any algorithm suitable for reducing the number of dimensions or eliminating irrelevant ones in a data set may be used, but PCA is widely used in e.g. machine vision applications. A PCA analysis may be described with the following five main steps [12].
standardization of the data, e.g. by averaging;
calculation of the covariance matrix of the data;
calculate of the eigenvectors using the covariance matrix;
selection of the principal components to be used;
formation of the new dataset by multiplying the standardized data with the corresponding eigenvectors.

The PCA analysis is performed using learning data obtained from the learning blood samples and their feature vectors, which are scaled to the interval [0,1]. In this way, the drop data fed to the classifier has the same scale in a space that was also used in the learning phase.

In addition to color information, also the size of the blood drop affects the purity analysis, as has been explained above. The feature descriptive of the size of a blood drop may be calculated based on the order of the drop within the sample, which depends on the size of it. Again, the value interval is [0,1], so the largest drop of the sample is given the value 1, the second largest 0.9, and so on, the minimum being 0. The final feature space is formed by incorporating the size data to the histogram data, to get a standardized data set for the features of each blood drop, in this case concentrating on color information.

### Support Vector Regression (SVR)

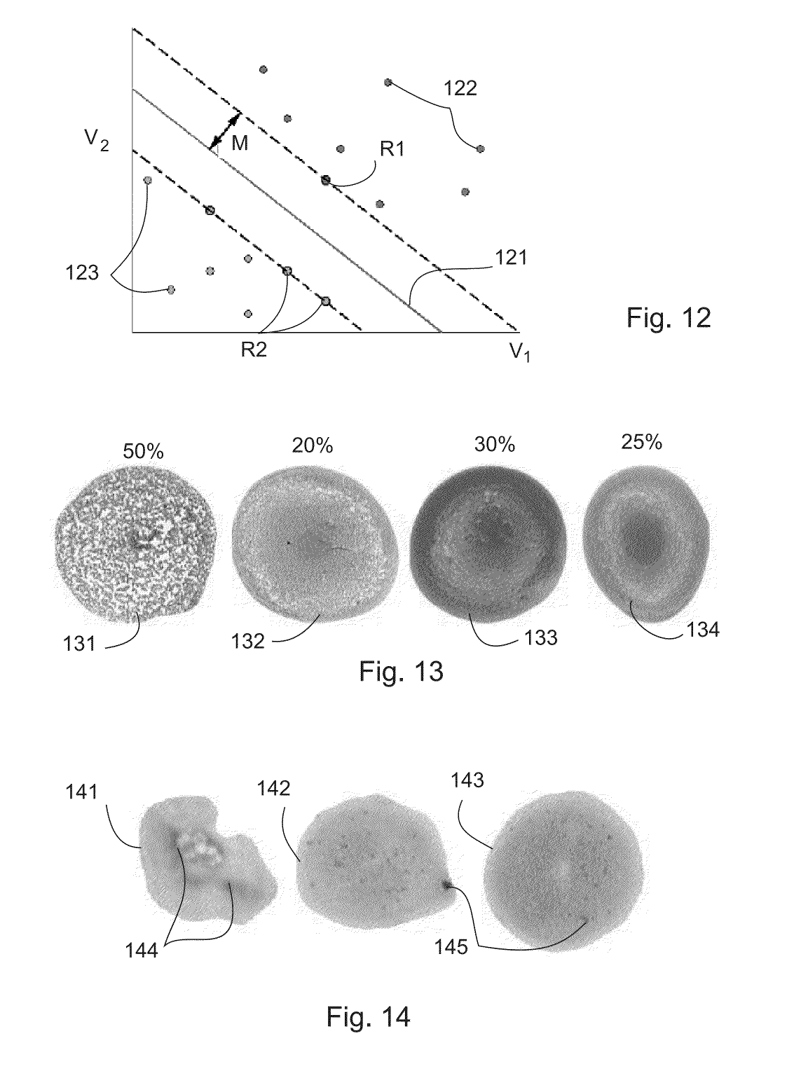

The SVR is a method for solving regressive classification problems, where distinct and unambiguous object classes are not available, but where the classification must be done on a sliding scale. One example of such problems is predictions concerning time. SVR is based on algorithms that try to find a decision (or dividing) plane between learning samples that maximizes the margins to the objects on both sides of the plane. The objects being closest to the plane, i.e. the objects defining the margins, are called support vectors. FIG. 12 shows the formation of an optimal decision borderline 121 in a two-dimensional feature space V1, V2, where the classes of samples 122, 123 are shown on each side of the borderline. The support vectors are marked with R1 and R2. The decision plane margin M is marked with an arrow.

In the example of FIG. 12, the classes are completely separable, but this is not always the case. In such cases cost functions are used, that assigns a cost to each learning sample depending on whether it is inside a class or not. In the real world, cost functions are not always providing results that are accurate enough and one solution is then to use kernel functions [3]. With kernel functions, vectors can be transferred from one space to another using nonlinear mapping. It is then possible with the SVR to transfer the vectors to a space with more dimensions than in the original space, where the classes can be separated by hyper-planes. That is why it is important to standardize and preprocess (simplify) the learning data histograms with e.g. the PCA algorithm, otherwise the learning process in a SVR classifier would be almost impossible to carry out in a case like this, due to computation demands.

The SVR classifier was implemented by using the LIBSVM library Level Set Function (LSF) methods [13], a collection of SVR classifiers for various purposes. The learning data consists of blood drops segmented by the method explained above in connection with the Bayesian classifier and Level Set Function method used. Every drop was given a sliding class value between [0,1] by a human, an experienced dry blood analyst, which evaluated and classified the drops in 5% purity intervals. The purity value corresponds to the amount of red blood in each drop, and the color space components given consideration in the learning process are based on the color and size histograms created in the preparatory phase as described previously. The teaching of the classifier can of course be repeated for several colors separately, if more than one component other than the desired or interesting color component in the liquid need to be identified and quantized. In the case of blood, the dark spots present in dry blood are however more economical to process by other means, as is explained later on.

FIG. 13 shows examples of drops 131-134 used in the learning process. The percentages above each of the drops express their whiteness value.

The classifier is learned by cross-validation and using a non-linear x²-kernel function, which works well with histograms. In cross-validation the learning is repeated several times, each time having some of the samples randomly selected and used for validation, and the rest used for learning. The cross-validation may be repeated for different color space histograms and PCA models, in order to find the one that produces the best classification result, measured e.g. by the mean square error between the classification of the validation data by the SVR classifier on one hand, and the original classification data made by the human on the other hand, as mentioned above.

In order to be complete, the dry blood analyzing concept must also provide consideration of dark spots that frequently appear in dry blood samples. The spots are generally small and circular, but may vary in appearance and size. FIG. 14 shows examples of drops containing dark spots, where the left-most drop 141 has spots 144 with a large mass, while the spots 145 in the other drops 142, 143 are dispersed and small.

First the drops are scaled to about the same size to make the nature of the dark spots independent of the amount of pixels in the drop image. Then a Gaussian filter [16] is applied to fade out the dark texture caused by fibrin in the blood. After this, the dark spots are identified by using an algorithm to identify the dark spots, the MSER (Maximally Stable Extremal Regions) method [14], in connection with the VLFeat-library [15], specialized in machine vision algorithms.

In principle, the algorithm works in the following steps:
apply a threshold t to a grey scale picture;
pixels with a value less than t are marked as black, the others white;
increase the threshold value t to let local intensity minimum areas (black pixels) grow;
select the dark spot candidates;
apply the threshold growth analysis to the selected candidates and validate/reject.

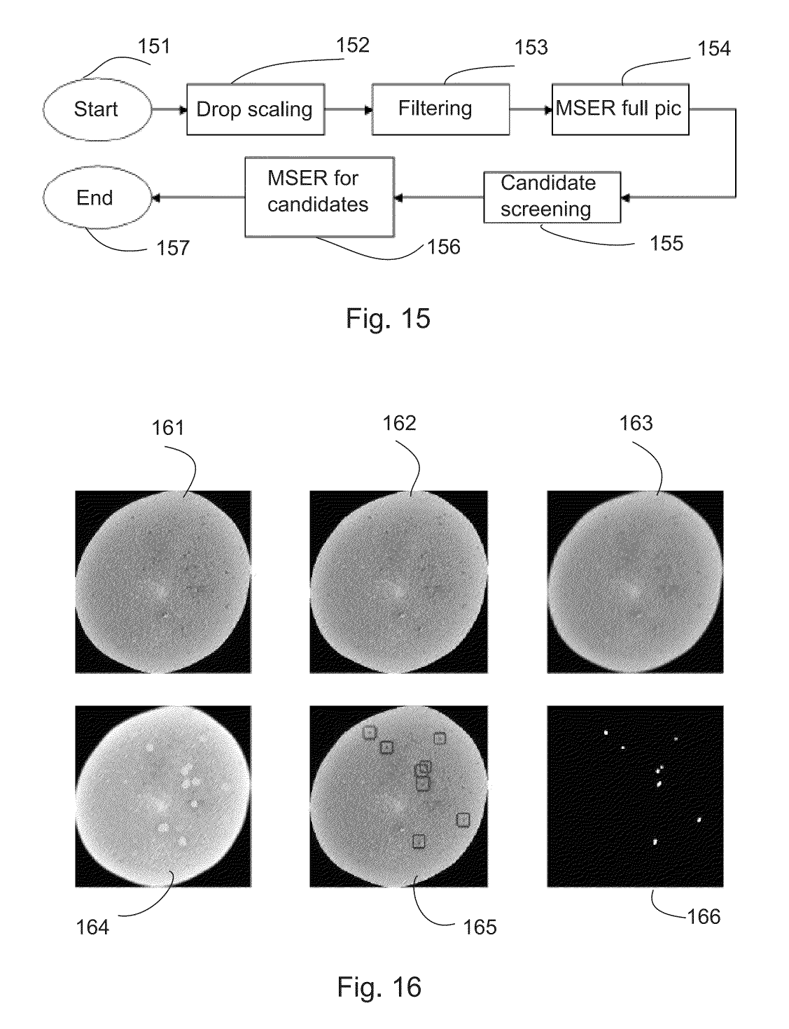

FIG. 15 shows a flowchart 151-157 on the detection of dark spots. Scaling 152 and filtering 153 of the sample drops is followed by a MSER selection process 154, 155 which includes identification and rejection of spots whose grey scale average is lighter than the average of the whole picture. Also spots which are clearly red are rejected. Also a certain evenness of the greyscale of the spot is expected, except for large spots which may be white in the center. In the final phase 156 the MSER algorithm is repeated for the qualified spots in the original image, to eliminate fibrin texture. Thereafter the picture is called back to its original size, the pixels occupied by the spots are counted and accounted for as a blood quality impairing factor.

FIG. 16 shows an example of a drop where the dark spots have been located.

In the upper row:

left-most is an image 161 of the original drop, in the middle a greyscale version 162 of the same, and to the right a filtered greyscale image 163. The share of the area of the dark spots of the total area of the exemplary drop is about 0.35%.

In the lower row:

left-most 164 is shown the spot candidates found by the MSER-algorithm. In the middle 165 are the qualified spots of the image encircled, and in the rightmost image 166 a binary image of the qualified spots is shown.

### Blood Purity Calculation

When the white blood and dark spots have been measured, the blood purity may be calculated. This final step in the inventive method means calculating the ratio of the predominant color, in this case red as representative of red blood, to the total sample area including the summed and classified areas of white blood and dark spots. This is done by first summing all the pixels from all the blood drops qualified for processing, i.e. all the pixels A with blood information only:

$$A = {\sum }_{i = 1}^{{n}_{s}} {a}_{i} , \qquad ( 3 )$$

where nₛ is the number of blood drops in a sample s and aᵢ the pixel count for an individual blood drop. The amount wₛ of white blood present in one sample is given by

$${w}_{s} = \frac{{\sum }_{i = 1}^{{n}_{s}} {w}_{i} {a}_{i}}{A} , \qquad ( 4 )$$

where wᵢ is the share of white blood in an individual drop. The share dₛ of dark spots may correspondingly be calculated as

$${d}_{s} = \frac{{\sum }_{i = 1}^{{n}_{s}} {d}_{i}}{A} , \qquad ( 5 )$$

where dᵢ is the amount of the summed pixels of the dark spots in one drop. Using formulas 3-5, we can now produce the purity measure pₛ of a specific sample:

pₛ=1−wₛ−dₛ. (6)

The measure of the purity of the blood is determined by the average of all the samples taken at the same time:

$$\overline{p} = \frac{{\sum }_{s = 1}^{N} {p}_{s}}{{N}_{s}} , \qquad ( 7 )$$

where Nₛ is the number of samples.

### Example 1

### Verifying the Measurement Accuracy

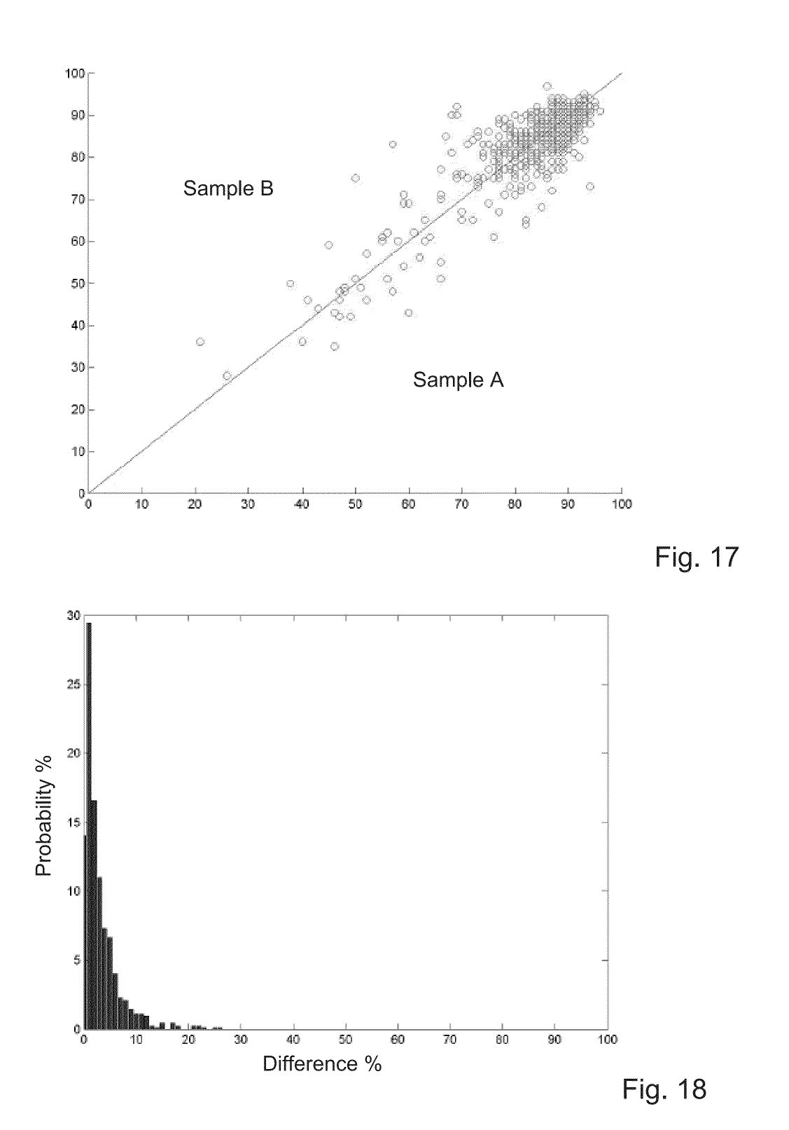

In determining the reliability of the results regarding blood purity, two samples A and B taken from the same person at the same time were compared for correlation. The computation of the blood purity was done in a test run with 920 samples, using a two-dimensional classifier based on a HS (hue & saturation)-histogram. The correlation coefficient used was the Pearson correlation coefficient, which has values between [−1, 1]. The closer the coefficient is to the values 1 or −1, the better the linear equation describes the relation between two variables. A value of 0 means there is no linear relationship. Here, for the used test samples the Pearson correlation coefficient was 0.863, which shows a quite good correlation between two samples. FIG. 17 shows a graph on the correlation between the two samples A and B, where in all 920 sample groups were formed, each being represented by a dot on the graph. Another measure is to calculate the p-value of the results. The p-value indicates the probability of which the same correlation would be achieved assuming by using random samples. For the 920 samples collected, the p-value is 1,417*10⁻²⁰², when the minimum criteria for a statistically significant result is P=0.001.

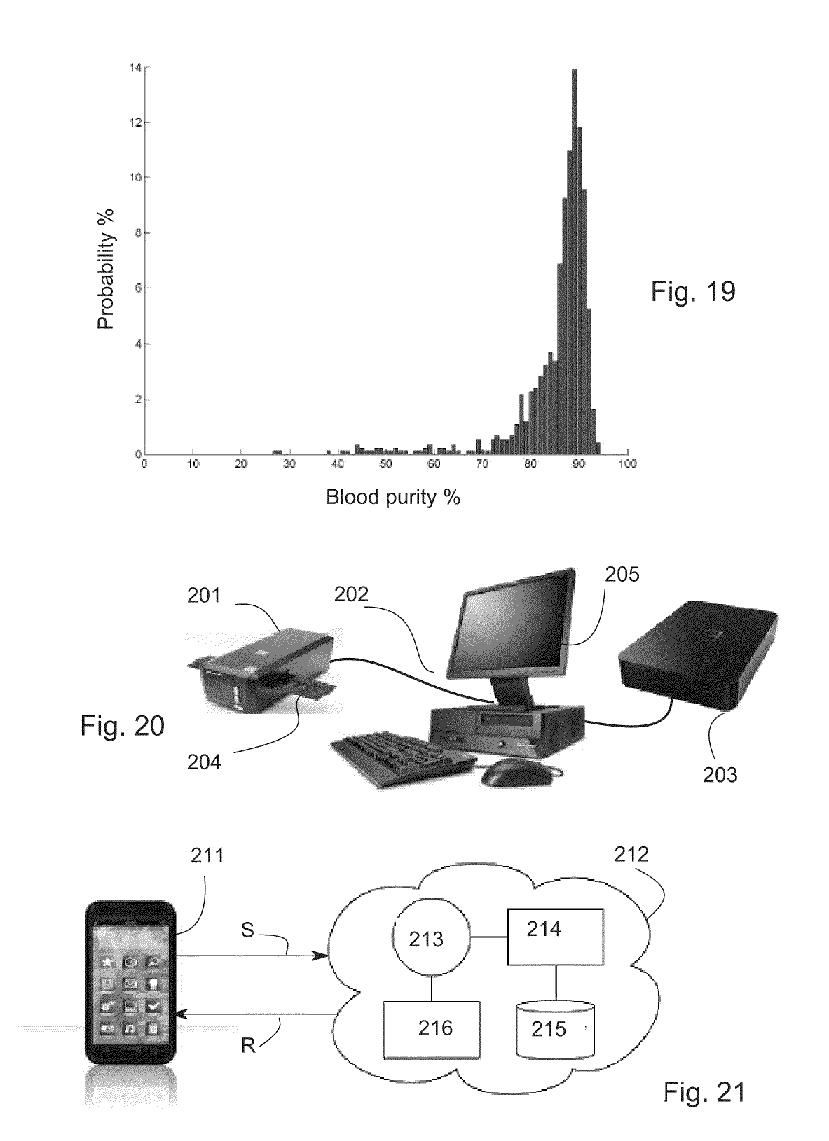

FIG. 18 is a bar chart over the difference distribution between the absolute values of two samples as taken as above, showing that the average difference is 3.01%, meaning the classifier has succeeded with a quite good accuracy to classify two samples to the same purity vale area. FIG. 19 shows a bar chart over the distribution of the blood purity values. The purity average of the tested 920 samples was 85.2%. No samples were completely clean, which is according to realistic expectations. Also the low number of low purity values is according to expectations, as all persons of the sample group with blood purity below 50% were hospital patients.

### Example 2

### Equipment

The scanning devices used for taking the original pictures of the live blood samples are commercial grade photo and slide scanners. Both worse and better scanners exist than those mentioned below. Epson Perfection V550 Photo has the best price-to-quality ratio of those used, and Epson Perfection V600 Photo is the best slide scanner that were, both with a 2400 dpi resolution.

As shown in FIG. 20, a general-purpose or special computer 202 with associated storage 203 and display 205 means is of course needed to store the algorithms, data and configurations for the inventive method, to read the image data from the scanning device 201 and to execute the method with all its parts. A slide scan tray 204 is also suitable for transferring dry blood samples to be scanned and processed according to the present invention.

As an alternative to the scanning device and computer configuration described above, the inventive method may also be used utilizing the high-resolution cameras of today's smartphones and similar devices. In such a case, shown in FIG. 21, it possible for the patient or user himself to take the blood samples, capture one or more pictures of the blood drop samples with a smartphone 211 camera, and sending (arrow S) it to a service on the internet or in the “cloud” 212. Such a service may consist of a service provider's interface 213, a processing platform 214 with storage and databases 215, and of an infrastructure block 216, including e.g. billing and customer records. The service would then analyze the sample pictures and return the result (arrow R) to the user's smartphone 211.

Other equipment include glass substrates or slides that can be 76×26 mm with a thickness of approx. 1.0-1.2 mm, lancets to puncture the skin, and cleaning towels. Obviously, a multitude of other equipment or medical instruments may be used for various supporting purposes, but it is not necessary to produce a complete list here, as such instruments may greatly vary depending on the liquid to be tested, the circumstances, and the staff performing such tests.

### Example 3

### Working Procedure

For taking a sample of dry blood from a client, the following steps may be taken:
check that the slides are clean;
mark the client's initials and sample number on the slide;
wipe the client's fingertip clean;
perform puncture with the lancet in the middle finger, ring finger or little finger;
press the finger so that a pinhead-sized drop of blood emerges;
let the drop dry for about half a minute;
press the slide lightly against the drop taking 8 subsequent samples;
repeat similar procedures with the other dry blood samples to attain a minimum of two high quality samples;
let the dry blood samples dry for about 5 minutes;
scan the dry blood sample or preserve it for later processing.

### Example 4

### Service

The measure of blood purity may serve as an indicator for a physician to take a closer look at the health of a client and to make suggestions as to changes in habits and life style of the patient. Repeated dry blood tests may serve as follow-up information for continued discussions between the physician and the client on how any changes have affected the health.

Also, self-service facilities may be set up, not necessarily involving contribution from a physician at all. The present invention makes it possible to provide a service for analyzing dry blood samples according to the inventive method, by using a system based on a smartphone and a remote computer system. The system then provides the user with health-related information based on blood information. One such health-related service that is readily available is providing the erythrocyte sedimentation rate on a self-service basis. The basic methodology was described by Goldberger already in 1939 [17]. Goldberger classified dry blood samples in four classes depending on how much white blood was present in the blood, and revealed that there was a linear correlation between the purity of the blood and its sedimentation rate. The purer the blood was the slower was the sedimentation rate.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of algorithms, filters, shapes, etc., to provide a thorough understanding of embodiments of the invention. One skilled in the relevant art will recognize, however, that the invention can be practiced without one or more of the specific details, or with other methods, components, materials, etc. In other instances, well-known methods, materials or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

### REFERENCES

[1] Berge H., Taylor D., Krishnan S. & Douglas T. (2011) Improved red blood cell counting in thin blood smears. In: Biomedical Imaging: From Nano to Macro, 2011 IEEE International Symposium on, pp. 204-207. DOI:
[2] Bolen H. (1942) The blood pattern as a clue to the diagnosis of malignant disease. J. Lab. & Clin. Med 27, pp. 1522-1536.
[3] Duda R. O., Hart P. E. & Stork D. G. (2001) Pattern Classification. Wiley, New York, 2. ed., 20-31 p.
[4] Cheng H. & Bouman C. (2001) Multiscale Bayesian segmentation using a trainable context model. Image Processing, IEEE Transactions on 10, pp. 511-525. DOI:
[5] Xia Y., Wang J., Eberl S., Fulham M. & Feng D. (2011) Brain tissue segmentation in PET-CT images using probabilistic atlas and variational Bayes inference. In: Engineering in Medicine and Biology Society, EMBC, 2011 Annual International Conference of the IEEE, pp. 7969-7972. DOI:
[6] Wang J., Xia Y., Wang J. & Feng D. (2011) Variational Bayes Inference Based Segmentation of Heterogeneous Lymphoma Volumes in Dual-Modality PET-CT Images. In: Digital Image Computing Techniques and Applications (DICTA), 2011 International Conference on, pp. 274-278. DOI:
[7] Li C., Xu C., Gui C. & Fox M. D. (2010) Distance Regularized Level Set Evolution and its Application to Image Segmentation. IEEE Trans. Image Process. 19, pp. 3243-3254.
[8] Szeliski R. (2010) Computer Vision: Algorithms and Applications. Springer-Verlag New York, Inc., New York, N.Y., USA, 1st ed.
[9] Martinez A. & Kak A. (2001) PCA versus LDA. Pattern Analysis and Machine Intelligence, IEEE Transactions on 23, pp. 228-233. DOI:
[10] Bishop C. M. (2006) Pattern Recognition and Machine Learning (Information Science and Statistics). Springer-Verlag New York, Inc., Secaucus, N.J., USA.
[11] Goldberger E. A rapid bedside test for measuring sedimentation rate. N.Y. State Journal of Medicine 1939.
[12] Shlens J. (2005) A tutorial on principal component analysis. In: Systems Neuro-biology Laboratory, Salk Institute for Biological Studies.
[13] Chang C. C. & Lin C. J. (2011) LIBSVM: A library for support vector machines. ACM Transactions on Intelligent Systems and Technology 2, pp. 27:1-27:27.
[14] Matas J., Chum O., Urban M. & Pajdla T. (2004) Robust wide-baseline stereo from maximally stable extremal regions. Image and Vision Computing 22, pp. 761-767. British Machine Vision Computing 2002.
[15] Vedaldi A. & Fulkerson B. (2008), VLFeat: An Open and Portable Library of Computer Vision Algorithms.
[16] Stockman G. & Shapiro L. G. (2001) Computer Vision. Prentice Hall PTR, Upper Saddle River, N.J., USA, 1st ed., 95, 279-325 p.
[17] Goldberger E. 1939. A rapid bedside test for measuring sedimentation rate. N.Y. State J.M.

1. A method for analyzing samples of a dried liquid, including the steps of:
providing a plurality of dried drops of said liquid as samples on at least one substrate;
scanning said at least one substrate and creating an image of the dried samples on the substrate;
processing the image of the samples in order to segment and qualify the samples into images of defined sample drops for further processing;
grouping the defined sample drops into at least one group of samples;
analyzing the defined sample drops to retrieve the total areas having at least one predetermined color;
summing the retrieved areas of the defined sample drops to retrieve the total areas for each of the predetermined colors in said drops, and
calculating a ratio of the total area of the defined sample drops versus the total areas of the at least one predetermined color areas to achieve a quality indication of the liquid.

2. The method according to claim 1, wherein the analysis of the defined sample drops to retrieve the area of at least one predetermined color is performed by classifying based on learning data.

3. The method according to claim 2, further including the step of processing learning data images by a Principal Component Analysis by:
standardizing the learning data by averaging;
calculating a covariance matrix of the data;
calculating a eigenvectors using the covariance matrix;
selecting a principal components to be used; and
forming a new dataset by multiplying the standardized learning data with the corresponding eigenvectors.

4. The method according to claim 2, further comprising the step of learning a Support Vector Regression classifier by feeding learning data consisting of dried sample drops being classified in purity intervals corresponding to the amount of the predetermined color component in each drop.

5. The method according to claim 1, wherein the analysis of the defined sample drops to retrieve the area of at least one predetermined color is performed by an algorithm further comprising:
providing a grey scale picture and applying a threshold to it;
marking pixels either black or white depending on their value in relation to said threshold;
increasing said threshold value to find and grow local intensity minimum areas;
selecting the dark spot candidates; and
applying the threshold growth analysis again to selected dark spot candidates and validating or rejecting the candidates.

6. The method according to claim 1, wherein processing a sample image of the samples includes applying a Naive Bayes classifier to a color histogram to create a probability picture as a defined digital representation of the dried liquid drops on the substrate.

7. The method according to claim 1, wherein processing a sample image includes performing a segmentation by a Level Set Function in order to fade out the background surrounding the dried liquid drops and forming definite sample drop outlines.

8. The method according to claim 1, wherein processing a sample image includes applying a Hough transform to identify lines conveyed from the sample substrate to the image and applying contrast enhancing, morphology operation and filtering techniques in order to improve the accuracy of the transform and to form sample dividing line candidates in the image.

9. The method according to claim 1, wherein processing a sample image includes a Linear Discriminant Analysis classifier and a mean vector, in order to produce a dividing line between the dried sample drops where the mean distance from the center of mass from each drop is maximized and the same on both sides of the line.

10. The method according to claim 1, wherein the liquid is blood and a predetermined color to be analyzed and summed is white.

11. The method according to claim 1, wherein the liquid is blood and a predetermined color to be analyzed and summed is black or dark with black as a predominant color.

12. The method according to claim 1, wherein the liquid is blood and wherein obscure blood samples are eliminated from the sample groups before retrieving the area of a predetermined color by a rejection algorithm based on color information of the drops and by comparison to learning data.

13. A system for analyzing samples of a dried liquid, comprising:
an imaging device for creating an image of dried samples on at least one substrate;
a non-transitory computer readable storage medium for storing image data and program products for processing image data; and
a computer adapted to:
process the image of the samples in order to segment and qualify the samples into images of defined sample drops for further processing;
group the defined sample drops into at least one group of samples;
analyzing the defined sample drops to retrieve the total areas having at least one predetermined color;
sum the retrieved areas of the defined sample drops to retrieve the total areas for each of the predetermined colors in said drops; and
calculate a ratio of the total area of the defined sample drops versus the total areas of the at least one predetermined color areas to achieve a quality indication of the liquid; as well as
a display for showing the calculated quality indication to a user of the system.

14. The system according to claim 13, wherein the imaging device is a scanner for scanning photographic pictures into a digital image format connected to a computer, said scanner being adapted to scan and image dried liquid samples on a substrate and to send the images to said computer for further processing.

15. The system according to claim 13, wherein the imaging device is a personal device equipped with a camera and adapted to take and send pictures of dried liquid samples to a remote computer for further processing, and to receive and display a quality indication of said liquid from said remote computer.

16. A non-transitory computer readable medium having stored thereon a set of computer executable instructions for causing a processor of a computing device to carry out the steps of:
scanning a substrate having a plurality of dried samples of a liquid and creating an image of the dried samples on the substrate;
processing the image of the samples in order to segment and qualify the samples into images of defined sample drops for further processing;
grouping the defined sample drops into at least one group of samples;
analyzing the defined sample drops to retrieve the total areas having at least one predetermined color;
summing the retrieved areas of the defined sample drops to retrieve the total areas for each of the predetermined colors in said drops, and
calculating a ratio of the total area of the defined sample drops versus the total areas of the at least one predetermined color areas to achieve a quality indication of the liquid.
